(19) United States
(12) Patent Application Publication
(10) Pub. No.: US 2008/0024485 A1
(43) Pub. Date: Jan. 31, 2008

(54) MULTI-DIMENSIONAL IMAGE DISPLAY METHOD APPARATUS AND SYSTEM

(76) Inventors: William Barrett, Provo, UT (US); Christopher Armstrong, Coeur d' Alene, ID (US); Brian Price, Provo, UT (US)

Correspondence Address: UTAH VALLEY PATENT SERVICES, LLC, 846 S. 1350 E., PROVO, UT, 84606, US

(21) Appl. No.: 11/779,274

(22) Filed: Jul. 17, 2007

Related U.S. Application Data
(60) Provisional application No. 60/831,885, filed on Jul. 18, 2006.

(51) Int. Cl. G06T 15/00

(52) U.S. Cl. 345/419

(57) ABSTRACT

A method, apparatus, and system are disclosed for displaying a multi-dimensional image. The present invention enables real time extraction and interaction with surfaces contained within a multi-dimensional image volume.

### RELATED APPLICATIONS

This application claims priority to U.S. Provisional Patent Application No. 60/831,885 entitled “Live Surface Software for Three Dimensional Object Segmentation” and filed on 18 Jul. 2006 for William A. Barrett, Chris Armstrong, and Brian Price, which Application is incorporated herein by reference.

### FIELD OF THE INVENTION

The invention relates to the process of viewing a three dimensional image. Specifically, the invention relates to devices, methods, and systems for extracting and displaying surfaces within an image volume.

### DESCRIPTION OF THE RELATED ART

Current segmentation techniques enable the extraction of surfaces from a multi-dimensional image volume. The extracted surfaces often enable accurate measurements in both industrial and medical applications. However, currently available segmentation systems are lacking in segmentation accuracy, rendering speed, and user interactivity. Surfaces can be extracted, but not manipulated in real time.

### SUMMARY OF THE INVENTION

The present invention has been developed in response to the present state of the art, and in particular, in response to the problems and needs in the art that have not yet been fully solved by currently available image segmentation methods. Accordingly, the present invention has been developed to provide a method, apparatus, and system to facilitate real-time image segmentation of multi-dimensional images that overcome many or all of the above-discussed shortcomings in the art.

In one aspect of the present invention, a method to segment and display a multi-dimensional image includes receiving a multi-dimensional image comprising a plurality of image elements, clustering adjacent image elements that are similar into image clusters, recursively clustering adjacent clusters that are similar to thereby generate a hierarchy of image clusters corresponding to the multi-dimensional image. The method may also include computing an adjacency graph for each non-root level of the hierarchy of image clusters, enabling a user to select foreground clusters, and descending through the adjacency graphs and segmenting each adjacency graph into foreground clusters and background clusters, and displaying a foreground image corresponding to the foreground clusters to the user.

Examples of metrics associated with each image element within an image volume include a color vector or an intensity level. In one embodiment, the hierarchy of image clusters comprises a tree. An adjacency graph may be associated with, or embedded within, each level of the hierarchy of image clusters. Vertices of each adjacency graph may correspond to image clusters and edges of each adjacency graph may be assigned a weight representing a similarity between adjacent image clusters. The weight may be calculated as an inverse of a sum of one and a squared difference in the average of one or more metrics associated with each image element within adjacent image clusters.

In certain embodiments, the user may select an image cluster as a foreground cluster or seed. In some embodiments, the foreground seed is planted in response to a left mouse click on the foreground image. In one embodiment, a mouse click on either the cross-sectional view or the surface view may plant a foreground seed. In certain embodiments, background clusters or seeds may also be selected by the user. In one embodiment, a background seed is planted in response to a right mouse click on either a cross-sectional view or a surface view. The described method uses the foreground or background seeds as references and descends through the adjacency graphs, segmenting each graph into foreground and background clusters. Additionally, clusters not adjacent to a segmentation may be pruned while descending through the adjacency graphs.

The foreground clusters that remain after the cascaded segmentation of the cluster hierarchy may be displayed to the user for analysis and review. In one embodiment, a foreground image corresponding to the foreground clusters is displayed to the user as a surface view. Controls may be provided that enable a user to rotate the foreground image, display a cross-sectional view, or rotate the cross sectional view. In one embodiment the cross-sectional view may be adjusted in response to the user moving a scroll wheel.

In another aspect of the present invention, an apparatus for displaying a multi-dimensional image may be a computing device provided with a plurality of modules configured to execute interactive image segmentation based on user input. In one embodiment, the computing device includes a receiving module configured to receive and store a multi-dimensional image and a clustering module configured to cluster adjacent image elements that are similar into image clusters. The clustering module may be further configured to recursively cluster adjacent image clusters that are similar and thereby generate a hierarchy of image clusters corresponding to the multi-dimensional image.

The computing device may also include an adjacency computing module configured to compute an adjacency graph for each non-root level of the hierarchy of image clusters. Additionally, a cluster formation module may be configured to accept user selection of foreground clusters and/or background clusters. The cluster formation module may utilize the user selection to descend through the adjacency graphs and segment each adjacency graph into foreground clusters and background clusters, where the foreground clusters comprise the foreground seeds selected by the user. In one embodiment, the segmentation is achieved using a graph cut algorithm. The computing device may also be provided with a display module configured to display a foreground image corresponding to the foreground clusters to the user.

In another aspect of the present invention, a system to display a multi-dimensional image includes one or more input devices configured to receive user input and a computing device configured to receive a multi-dimensional image. The computing device may include an interactive image rendering module configured to cluster similar image elements that are adjacent into image clusters. The interactive image rendering module may also be configured to recursively cluster adjacent image clusters that are similar to generate a hierarchy of image clusters corresponding to the multi-dimensional image.

The interactive image rendering module may also be configured to compute an adjacency graph for each non-root level of the hierarchy of image clusters, accept user selection of foreground clusters or seeds and descend through the adjacency graphs and segment each adjacency graph into foreground clusters and background clusters. The system may also include a display configured to display a selected foreground image corresponding to the foreground clusters to the user.

The present invention provides distinct advantages over the prior art. Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram depicting one embodiment of a multi-dimensional image display system in accordance with the present invention;

FIG. 2 is a block diagram depicting one embodiment of a multi-dimensional image display apparatus in accordance with the present invention;

FIG. 3 is a schematic flow chart diagram illustrating one embodiment of a multi-dimensional display method in accordance with the present invention;

FIG. 4 is a schematic flow chart diagram illustrating a cascading segmentation method in accordance with the present invention;

FIG. 5 is an example of a cross section of an image volume at varying stages of cascading segmentation; and

FIG. 6 is a set of screenshots depicting one embodiment of a multi-dimensional image interface in accordance with the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a signal bearing medium or computer readable medium may take any form capable of generating a signal, causing a signal to be generated, or causing execution of a program of machine-readable instructions on a digital processing apparatus. A signal bearing medium may be embodied by a transmission line, a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

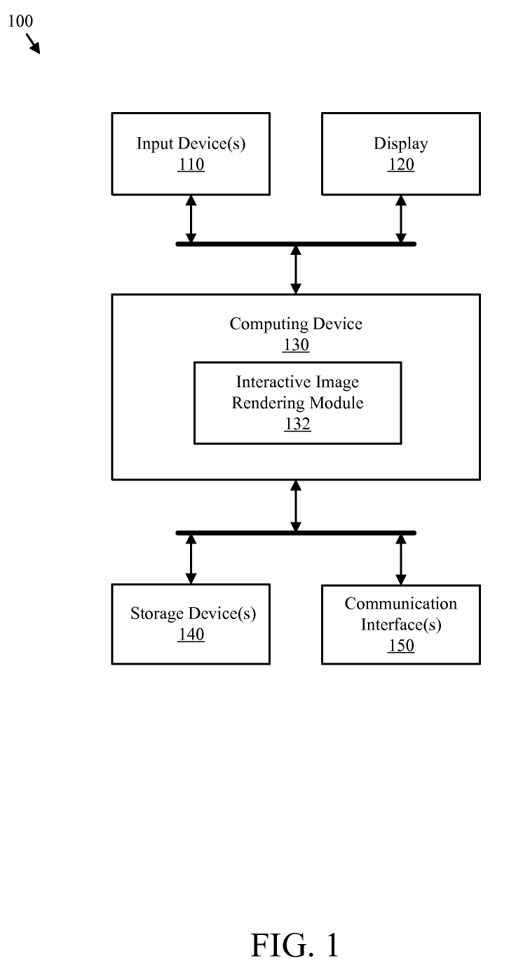

FIG. 1 is a block diagram depicting one embodiment of a multi-dimensional image display system 100 in accordance with the present invention. As depicted, the multi-dimensional image display system includes one or more input devices 110, a display 120, a computing device 130 with an interactive image rendering module 132, one or more storage devices 140, and one or more communication interfaces 150. The system depicted in FIG. 1 enables a user and/or an automated input device 110 to control image rendering and relay rendered images to a display, storage device, communication interface, or other device or interface.

The input devices 110 provide input pertaining to the multi-dimensional image display system 100. In one embodiment, the input devices 110 deliver one or more streams of data based on user input. Examples of input devices include a pointing device, a mouse, a keyboard, a joystick, or the like. Additionally, the input devices may deliver a set of automation commands to perform specific image manipulations and extract relevant data and image surfaces.

The display 120 includes the necessary components to render images, volumes, surfaces, user input, and/or any other information relevant to a multi-dimensional image display system. In one embodiment, the display 120 receives instructions from a graphics card and specifications from an image rendering specification such as openGL. The display 120 may further display the status of devices and processes involved in image rendering.

The computing device 130 is a processing unit equipped with an interactive image rendering module 132 configured to receive and execute commands pertaining to an image or volume. Examples of a computing device include, but are not limited to personal computers, tablet pcs, handheld computers, cell phones, standalone processors, data servers, and any other computing device with a processor.

The interactive image rendering module 132 includes the necessary hardware and software elements to render an image in real-time based on user input. The rendered images may be three dimensional images and surfaces that are extracted from voxel data at sub-second rates, presenting a significant efficiency advantage over prior art solutions. The interactive image rendering module 132 may leverage with one or more storage devices 140 to improve speed and performance.

In one embodiment, the storage devices 140 store preprocessed information such as surface patches and surface patch locations. The computing device 130 may extract a hierarchy of data from a received image or image volume for use by the interactive image rendering module 132. The data may be temporarily placed on one or more storage devices 140 for subsequent use. The temporary storage of image volume elements enable the interactive image rendering module 132 to access predefined data and quickly render images.

The storage devices 140 may also be used for the long term storage of input data and extracted data. In one embodiment, the storage devices store extracted surfaces, original volumes, and records of user input. Examples of storage devices include, but are not limited to, random access memory, read-only memory, hard disks, CDs, DVDs, removable media, and external devices such as flash drives and external hard disks. The computing device 130 may control interaction with the storage devices 140.

The communication interfaces 150 transmit data, surfaces, image volumes and the like between the computing device 130 and other devices such as remote devices. The establishment of communication protocols may be conducted by the communication interface 150. Data verification may also be handled by the communication interface 150. Examples of the communication interface include, but are not limited to a network interface, a cell phone interface, a wireless interface, a serial or dual port interface, a USB interface, and the like.

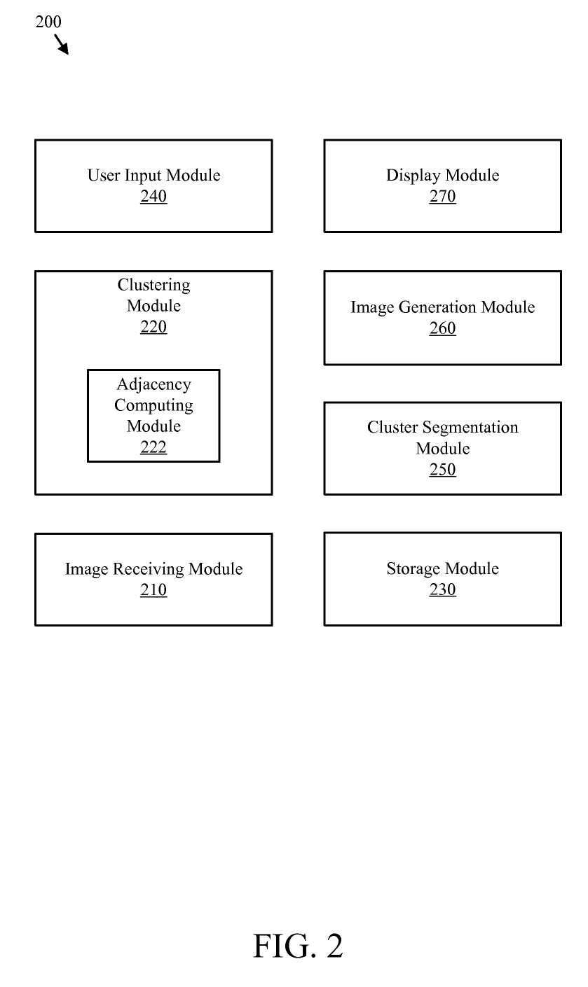

FIG. 2 is a block diagram depicting one embodiment of a multi-dimensional image rendering apparatus 200 in accordance with the present invention. As depicted, the multi-dimensional image rendering apparatus 200 includes an image receiving module 210, a clustering module 220, a storage module 230, a user input module 240, a cluster segmentation module 250, an image generation module 260, and a display module 270. The multi-dimensional image display apparatus 200 enables a user to select and view three dimensional components or cross sections out of a multi-dimensional volume. The multi-dimensional image display apparatus 200 is one example of the interactive image rendering module 132 depicted in FIG. 1.

The image receiving module 210 may receive multi-dimensional volume data from an external source such as a medical scanner or an image volume compiler. The received volume data may be organized as a multi-dimensional array of image elements. Each image element may have one or more metrics such as intensity or a color vector that collectively define the multidimensional image. In one embodiment, each image element is a voxel that corresponds to a spatial position in the multi-dimensional image. In another embodiment, each image element is a pixel that corresponds to a frame (i.e. specific time) and screen coordinate (i.e. specific position). The volume of each voxel or size of each pixel may be sufficiently small to ensure a high resolution representation of the multi-dimensional image.

The clustering module 220 groups adjacent image elements that have similar characteristics into larger image clusters. Image elements may be grouped based on various metrics such as gradient factors, RGB values, or intensity, where the intensity of individual image elements may be determined by density, estimated magnetic resonance, estimated positronic emissions, estimated electron emissions, or some combination thereof.

In certain embodiments, a tobogganing watershed algorithm is used to group similar image clusters. In one embodiment, the tobogganing watershed algorithm implements contrast and gradient analysis to generate catchment basins. Clusters with a common low point or catchment basin are merged into larger clusters. In one embodiment, the process is repeated until all clusters are associated with a single basin and merged to form a root-level cluster. With each subsequent clustering, the basins/clusters may be recorded and stored into a hierarchy for subsequent use. The generated hierarchy of clusters may form a complete partition of the image volume at each level in the hierarchy.

The clustering module 220 may also calculate the visible surface of each cluster. The calculated visible surfaces may be stored in the storage module 230 for recall by other modules. In one embodiment, the storage module 230 contains a look up table that stores a surface patch for each edge at the lowest level of the cluster hierarchy.

The clustering module 220 may resolve issues that arise from an extensive number of adjacent image elements with similar gradient values. Commonly referred to as a plateau, a high number of adjacent similar elements can cause undesired results. In one embodiment, the present invention recursively groups each image element with a six connected neighbor whose gradient magnitude is the smallest, with the condition that the neighbor's gradient magnitude is less than or equal to that of the original image element. By using a less than or equal to comparison when merging clusters, the generated clusters always slide or point to the same local minimum.

The user input module 240 receives user or device commands pertaining to the image volume. In one embodiment, the user input module interfaces to a mouse or pointing device that enables users to select a surface. The user input module 240 may also enable users to rotate the image volume and select cross sections of various rotational views. The user may also select layers to peel away or remove through means of the user input module 240.

The user input module 240 may also enable the user to generate foreground and background seeds based on user selection. The seeds may determine starting points for generating watershed hierarchies. In one embodiment, the seeds are propagated up the hierarchy from child to parent. Adjacency graphs may be formed at each level of the hierarchy by the adjacency computing module 222.

The cluster segmentation module 250 examines the hierarchy and the user specified seeds to determine an initial segmentation into foreground and background clusters. Large pieces of the volume may be moved to the background in order to greatly reduce the number of clusters needed for further segmentation.

Subsequent to initial segmentation, the cluster segmentation module 250 makes refining segmentations on the remaining clusters. Refining segmentations are made recursively, with a smaller clusters being analyzed with each segmentation. As the cluster hierarchy is traversed and segmented, the vast majority of clusters may be ignored by the cluster segmentation module 250. In one embodiment, the number of clusters included in refining segmentations depends on the surface area of the selected object, not the size of the volume, providing improved performance over prior art solutions.

The image generation module 260 takes the refined segmentations and uses the discovered surfaces to present the user with a multi-dimensional representation of the selected image elements. The image generation module 260 may reference the storage module 230 to quickly access surface patches for each edge. Using a combination of stored surfaces and surface calculations enables image formation in real-time. Perspective views may also be rendered in real time as well, enabling the user to immediately rotate the formed image. The image generation module 260 may also create an artificial light source to give perspective to the multi dimensional representation.

The display module 270 may display both the original volume as well as the image created by the image formation module 260. The display module 270 may be configured to present an interface for user interactivity. In one embodiment, the display module interfaces to a computer monitor.

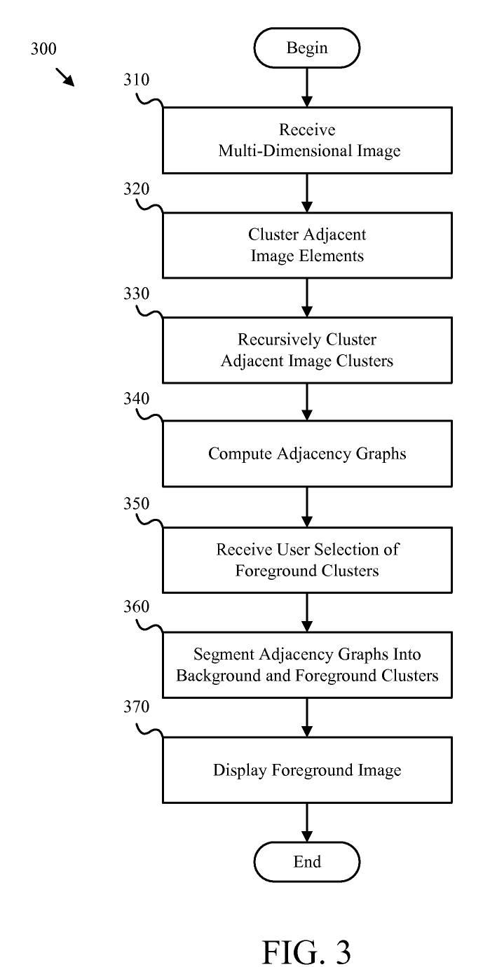

FIG. 3 is a flow chart depicting one embodiment of a multi-dimensional image display method 300. As depicted, the image display method 300 includes receiving 310 a multi-dimensional image, clustering 320 adjacent image elements, recursively clustering 330 adjacent image clusters, computing 340 one or more adjacency graphs, accepting 350 user selection of foreground clusters, sequentially segmenting 360 the adjacency graphs into background and foreground clusters, and displaying 370 the foreground image. The multi-dimensional image display method 300 enables the extraction of surfaces in real-time based on user input.

Receiving 310 a multi-dimensional image entails receiving an image volume. The received image volume may be composed of several dimensions, including, but not limited to, time and space. For example, the image volume might be composed of a series of screenshots or still frames taken over a period of time. In the case of a movie clip, for example, the movie may be compressed into an image volume where one of the relevant axes is time. Receiving 310 an image volume may further include using the image volume and associated metric(s) to determine the required algorithmic sensitivity. For example, the required sensitivity of watershed algorithms and color analysis may vary between an analyzed magnetic resonance image and a high resolution composite movie clip.

Clustering 320 adjacent image elements may also entail various clustering techniques depending on the nature of the received image volume. In the case of the movie clip, for example, image elements within a cross section or frame may be clustered before the frames are clustered together. Clustering image elements across the individual frame level allows for easier detection and handling of a jump in movie scenes. In one embodiment, clustering 320 adjacent image elements entails creating clusters of a relatively small volume.

In certain embodiments, recursively clustering 330 adjacent image clusters includes recursively clustering the clusters having a common catchment basin into larger clusters, in effect creating a hierarchy of clusters for subsequent use. In one embodiment, a t-score difference formula is used in place of a gradient magnitude to perform the clustering. The t-score formula may be implemented in specific instances where parametric modeling of color distribution between two clusters is more efficient than a gradient magnitude analysis. In one embodiment, the following t-score formula is used: T²=(Nₘ*Nₙ*∥Cₘ−Cₙμ²)/(Nₘ*Vₙ+Nₙ*Vₘ), where N is the number of image elements in a cluster. The subscripts m and n indicate which cluster is being referenced. C is the average color vector of the cluster and V is a measurement of the color variance of the cluster.

Recursively clustering 330 adjacent image clusters may entail repeated clustering until the image volume is reduced to a single cluster. Recursive clustering 330 of adjacent clusters facilitates building a hierarchy of clusters where each level represents a level of image granularity. The clusters at each level of the generated hierarchy may be mutually exclusive and exhaust the space defined by the volume. Clusters at all levels may be represented as nodes in the hierarchy where children nodes represent smaller clusters that cumulatively form larger clusters, and where the larger clusters are represented by parent nodes.

Computing adjacency graphs 340 includes computing an adjacency graph for each level of the cluster hierarchy. Computing adjacency graphs 340 may further include ordering the adjacency graphs in preparation for segmentation of the adjacency graphs into foreground and background clusters.

Accepting 350 user selection of foreground clusters may include receiving input that specifies seed image elements and a corresponding surface within the volume. The foreground and background seeds may be propagated throughout the hierarchy to define an initial set of foreground clusters and background clusters on each level of the cluster hierarchy. The adjacency graphs associated with each non-root level of the cluster hierarchy may then be sequentially segmented 360 into background and foreground clusters.

Displaying 370 the foreground image may include rendering the resulting foreground clusters in a visible form. Rendering the resulting foreground clusters may entail presenting multiple views and multiple dimensional perspectives of the foreground clusters on the lowest level of the cluster hierarchy. Displaying 370 the foreground image facilitates inspection of the results and the recognition of any discrepancies. A user selection, for example, might cause a seed propagation to include more surfaces than the user intended. In a specific case, where the volume is a human body generated from a medical scan, clicking on the edge of an organ might select multiple organs. The display shows the discrepancy and enables a user to make adjustments to remove non-relevant organs or reposition the foreground image to display only the relevant organ.

Displaying 370 the foreground image may include accessing preprocessed surfaces stored in the hierarchy. Accessing the preprocessed surfaces enables faster image rendering through the use of predetermined edge data, providing a significant speed advantage over having to calculate surfaces with each user action. In the present invention the display renders most volume data in sub-second speeds. In one embodiment, openGL specifications are implemented to enable the surface to be rendered. DirectX or a custom specification may be similarly implemented to provide similar results.

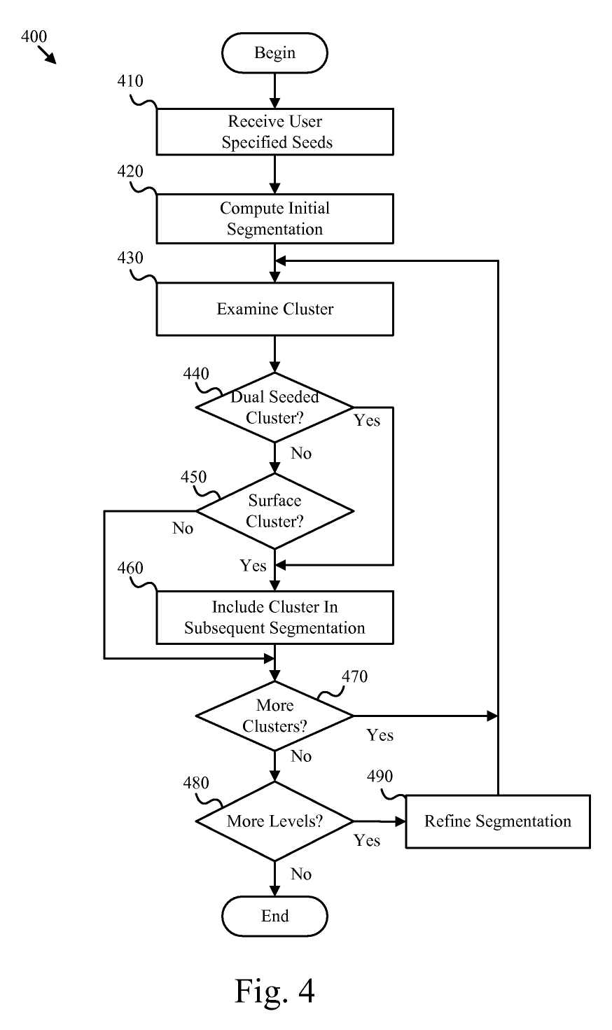

FIG. 4 is a flowchart depicting one embodiment of a cascading segmentation method 400. As depicted, the cascading segmentation method 400 includes receiving 410 user specified seeds, computing 420 an initial segmentation, examining 430 a cluster included in the most recent segmentation, determining 440 if the cluster is dual seeded, determining 450 if the cluster lies on a segmentation surface, including 460 the cluster in a subsequent segmentation, determining 470 if there are more clusters to process at the current level, determining 480 if more levels need to be processed, and making 490 refining segmentations at the next level. The cascading segmentation method 400 is one example of the sequential segmentation operation 360 depicted in FIG. 3.

The cascading segmentation method 400 takes a cluster hierarchy computed from an image volume and makes a series of refining segmentations until a very refined surface is generated. In one example, where the image volume is a computed tomography (CT) scan of a leg, the cascading segmentation method 400 would enable extraction of the femur, or surrounding tissue, or a composite of surfaces within the scanned image volume.

Through means of a pointing device, user interaction, or automated process, seeds are specified by the user. Receiving 410 user specified seeds entails finding those planted seeds. In one embodiment, only one foreground seed needs to be planted and one or more background seeds are automatically computed from the volume data. In one embodiment, receiving 410 user specified seeds includes propagating the discovered children seeds to parent seeds. For example, if the children seeds are foreground seeds the parent seed will also be a foreground seed. In cases where a cluster is a parent of both a foreground and a background seed, a dual seeded cluster is created.

The background and foreground seeds are then used to compute 420 an initial segmentation. The initial segmentation is a rough estimate of the surface based on the distinction between the foreground and background seeds. Examining 430 clusters included in the most recent segmentation entails examining the background and foreground seeds included in the previous segmentation. The clusters are labeled as foreground, background, or dual seeded clusters. If the cluster is determined 440 to be a dual seeded cluster, the cluster will be included 460 in a subsequent segmentation. A dual seeded cluster indicates that the user disagrees with the segmentation of clusters and that further refinements are needed in that area.

If a cluster is not dual seeded, the cluster is further examined to determine 450 if the cluster lies on the surface of the segmentation. If the cluster does fall along the surface of the segmentation, the cluster is relevant in the refining process and is subsequently included 460 in the next segmentation. If the cluster is not dual seeded and does not lie along the segmentation, the cluster is removed from further segmentation.

Determining 470 if there are more clusters entails examining the current level of the cluster hierarchy to determine if more clusters need to be evaluated. If there are additional relevant clusters, the process is repeated until all relevant clusters at the current level have been examined. Determining 480 if more levels need to be processed entails determining if the current level of the cluster hierarchy is the lowest level in the hierarchy. In one embodiment, the image elements included in the lowest level of the hierarchy may be examined to determine if further processing is required. If additional levels need to be processed, the children of the remaining clusters at the current level are used to compute a refined segmentation 490 at the next level of the hierarchy.

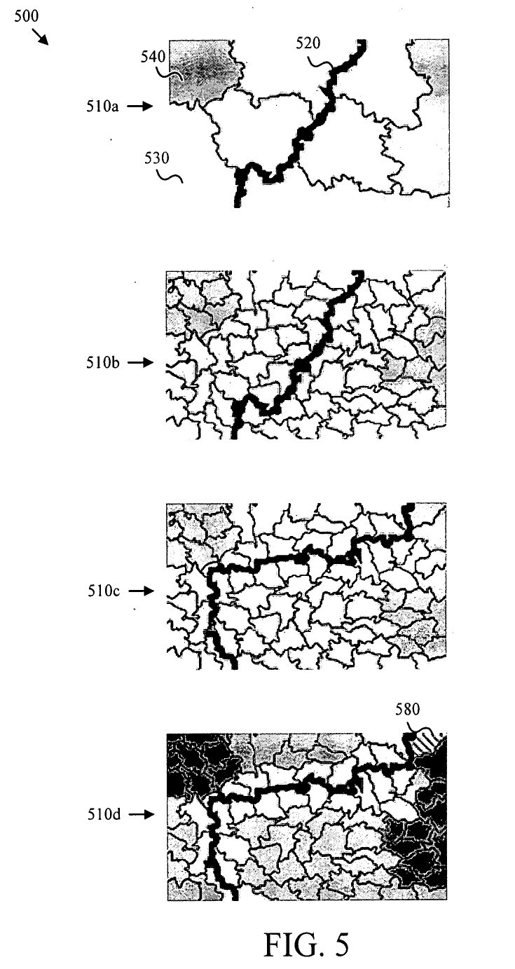

FIG. 5 is an example of a volume cross section 500 at varying stages of a cascaded segmentation of a cluster hierarchy. As depicted, the volume cross section 500 includes various segmentations 510, a surface segmentation 520, a cluster on the surface of the segmentation 530, a removed cluster 540, and a reincorporated cluster 580. The cascading segmentation is used to remove all clusters that are not directly adjacent to the segmentation and partitioning the clusters adjacent to the segmentation into foreground clusters and background clusters, thereby leaving only the small clusters that compose a visible surface. The result is a high resolution surface containing only the most detailed foreground clusters.

An initial segmentation 510a is composed of the largest clusters adjacent to (on the surface of) the segmentation 520. The clusters adjacent to the segmentation 530 are isolated and included in future refinements. The removed clusters 530, indicated in grey, are near the surface segmentation 520, but are not directly adjacent. Since the removed clusters do not touch the surface segmentation, those clusters are not used in the refining process to extract the visible surface. The removed clusters 530 may be ignored in further refinements and segmentation.

A refined segmentation 510b shows the results of an additional segmentation operation. Each cluster in the refined segmentation 510b represents a child cluster of the larger clusters that were included in the initial segmentation 510a. By breaking up the larger clusters into smaller child clusters, smaller outer clusters can be removed. Removing clusters recursively enables a more precise extraction of the surface and a faster analysis of the remaining clusters.

A cascaded segmentation 510c is the result of an additional segmentation operation applied to an already refined segmentation 510b. Again, the clusters not on the surface are ignored, and the result is a completely refined segmentation 510d. In certain cases, discarded elements may need to be reincorporated into the surface image. The reincorporated basin 580 is an example of a basin that was discarded based on an misguided segmentation operation. As the segmentation process is further refined, the surface may be determined to include discarded clusters such as the reincorporated basin 580.

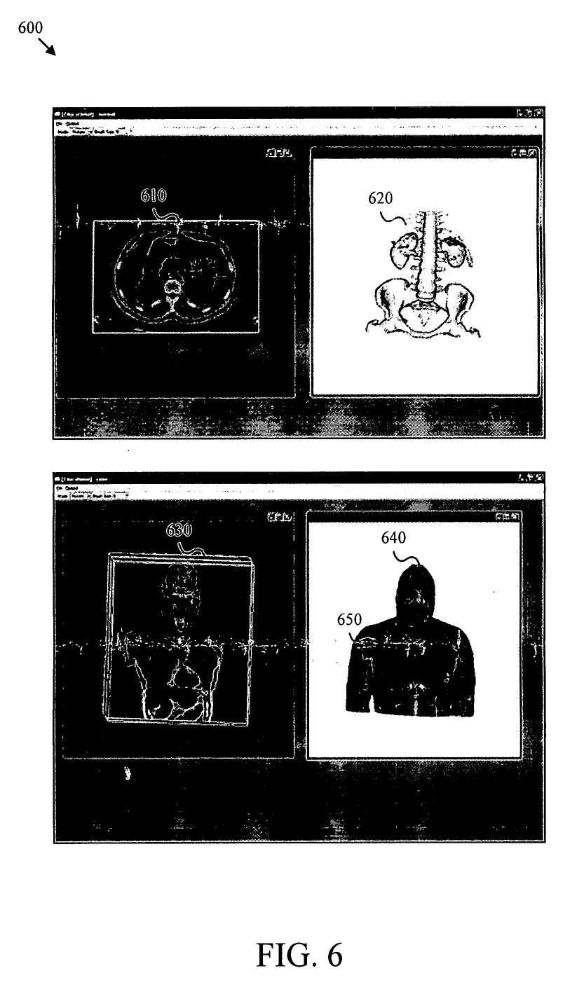

FIG. 6 is a set of screenshots depicting one embodiment of a multi-dimensional image display 600. As depicted, the multi-dimensional image display 600 includes a cross section of an image volume 610, an extracted surface 620, a complete image volume 630, a composite extracted surface 640, and underlying surfaces 650. The multi-dimensional image display 600 enables users to rotate image volumes, select relevant cross sections, and extract surfaces for viewing.

In some situations, a two dimensional view or a slice of a scan is preferred to a multi-dimensional image when selecting surfaces. The cross section of an image volume 610 may enable users to more easily seed images and select desired surfaces. Specifically, in the scan presented, selecting the spine and organs may be easier when a cross section is taken.

In one embodiment, the user can scroll through different cross sections by means of a mouse scroll wheel, enabling rapid access to all of the layers. The user may also toggle views or scope through similar user input. In a further embodiment, the selected regions are highlighted in a contrasting color to the background image. If a different view is toggled by user input, the contrasting color may remain on the entire selected surface, and not just on the cross section.

The selected surfaces may be displayed in a multi-dimensional format. In one embodiment, the extracted surface 620 is displayed in a separate window in a three dimensional presentation. The extracted surface 620 may be rotated and pieces may be added or removed through additional user input applied to the extracted surface. In certain embodiments, holding down a mouse button and dragging can serve as a means to rotate the extracted surface. In some embodiments, a right mouse click can remove a surface or a portion thereof. The entire extraction and refinement process may be executed entirely through a mouse control. In one embodiment there are no additional controls beyond the visible surfaces and a user input device.

Instead of a cross sectional view, the complete image volume 630 may be presented to the user. The complete image volume 630 may be used in cases where surface extraction is more easily executed on the complete volume. Skin, or outer tissue layers, for example, may be more easily selected on the complete image volume 630 than on a cross sectional view.

In one embodiment, a composite extracted surface 640 can be selected by the user. As shown, the multi-dimensional image display can simultaneously portray multiple independent surfaces. In one embodiment, the user can use the mouse or other input device to peel away or remove certain surface layers, exposing underlying surfaces 650. In the example shown, the skin has been peeled away to expose the underlying tissue. The present example denotes that a digital scalpel effect can be applied to expose underlying tissue that would not be viewable on a traditional scan.

In a particular real life example, a cardiac CT scan was performed but failed to display a stent graft in the descending aorta. Using the rotational format of the present invention and the ability to remove tissue surfaces, a medical professional was able to visually extract the stent graft surface for examination.

What is claimed is:

1. A computer program comprising a computer readable medium having computer usable program code executable to display a multi-dimensional image, the operations of the computer program product comprising:
receiving a multi-dimensional image comprising a plurality of image elements, each image element comprising at least one metric, each image element corresponding to a position within the multi-dimensional image;
using the at least one metric to cluster adjacent image elements that are similar into image clusters;
recursively clustering adjacent image clusters that are similar to generate a hierarchy of image clusters corresponding to the multi-dimensional image;
computing an adjacency graph for each non-root level of the hierarchy of image clusters;
enabling a user to select foreground clusters;
descending through the adjacency graphs and cutting each adjacency graph into foreground clusters and background clusters, the foreground clusters comprising the foreground clusters selected by the user; and
displaying a foreground image corresponding to the foreground clusters to the user.

2. A method for displaying a multi-dimensional image, the method comprising:
receiving a multi-dimensional image comprising a plurality of image elements, each image element comprising at least one metric, each image element corresponding to a position within the multi-dimensional image;
using the at least one metric to cluster adjacent image elements that are similar into image clusters;
recursively clustering adjacent image clusters that are similar to generate a hierarchy of image clusters corresponding to the multi-dimensional image;
computing an adjacency graph for each non-root level of the hierarchy of image clusters;
enabling a user to select foreground clusters;
descending through the adjacency graphs and segmenting each adjacency graph into foreground clusters and background clusters, the foreground clusters comprising the foreground clusters selected by the user; and
displaying a foreground image corresponding to the foreground clusters to the user.

3. The method of claim 2, further comprising pruning clusters that are not adjacent to a segmentation while descending through the adjacency graphs.

4. The method of claim 2, wherein selecting a foreground cluster occurs in response to a left mouse click on the foreground image.

5. The method of claim 2, further comprising enabling a user to select background clusters.

6. The method of claim 5, wherein selecting a background cluster occurs in response to a right mouse click on the foreground image.

7. The method of claim 5, wherein the background clusters selected by the user are used to segment each adjacency graph.

8. The method of claim 2, wherin foreground clusters may be selected from either a cross-sectional view or a surface view.

9. The method of claim 2, wherein the hierarchy of image clusters comprises a tree.

10. The method of claim 2, wherein vertices of each adjacency graph correspond to image clusters and edges of each adjacency graph are assigned a weight representing a similarity between adjacent image clusters.

11. The method of claim 9, wherein the weight is computed as an inverse of a sum of one and a squared difference in the average of the at least one metric within the adjacent image clusters.

12. The method of claim 2, wherein the at least one metric comprises a color vector.

13. The method of claim 2, wherein the at least one metric comprises an intensity level.

14. The method of claim 2, further comprising rotating the foreground image.

15. The method of claim 2, further comprising rotating the cross-sectional view.

16. The method of claim 2, further comprising displaying a cross-sectional view.

17. The method of claim 15, further comprising changing the cross-sectional view in response the user moving a scroll wheel.

18. The method of claim 2 wherein the multi-dimensional image is a video.

19. The method of claim 2 wherein the foreground image is a surface view.

20. An apparatus for displaying a multi-dimensional image, the apparatus comprising:
a receiving module configured to receive and store a multi-dimensional image;
a clustering module configured to cluster adjacent image elements that are similar into image clusters;
the clustering module further configured to recursively cluster adjacent image clusters that are similar to generate a hierarchy of image clusters corresponding to the multi-dimensional image;
an adjacency computing module configured to compute an adjacency graph for each non-root level of the hierarchy of image clusters;
a cluster formation module configured to accept user selection of foreground clusters;
the cluster formation module further configured to descend through the adjacency graphs and segment each adjacency graph into foreground clusters and background clusters, the foreground clusters comprising the foreground clusters selected by the user; and
display module configured to display a foreground image corresponding to the foreground clusters to the user.

21. A system for displaying a multi-dimensional image, the system comprising:
an input device configured to receive user input;
a computing device configured to receive a multi-dimensional image;
an interactive image rendering module configured to:
cluster adjacent image elements that are similar into image clusters,
recursively cluster adjacent image clusters that are similar to generate a hierarchy of image clusters corresponding to the multi-dimensional image,
compute an adjacency graph for each non-root level of the hierarchy of image clusters,
accept user selection of foreground clusters,
descend through the adjacency graphs and segment each adjacency graph into foreground clusters and background clusters, the foreground clusters comprising the foreground clusters selected by the user, and
display a selected foreground image corresponding to the foreground clusters to the user.
